(19) United States
(12) Patent Application Publication
(10) Pub. No.: US 2026/0303316 A1
(43) Pub. Date: Oct. 1, 2026

(54) SYNCHRONIZING CLOCKS OF NETWORK INTERFACE CARDS OF A SERVER USING SYSTEM CLOCK

(71) Applicant: Clockwork Systems, Inc., Palo Alto, CA (US)

(72) Inventors: Yilong Geng, Menlo Park, CA (US); Akram O. Sbaih, San Francisco, CA (US); Katherine Gioioso, Mountain View, CA (US); Balaji S. Prabhakar, Palo Alto, CA (US)

(21) Appl. No.: 19/631,732

(22) Filed: Mar. 27, 2026

Related U.S. Application Data
(60) Provisional application No. 63/780,052, filed on Mar. 28, 2025.

(51) Int. Cl. H04L 7/00

(52) U.S. Cl. CPC H04L 7/0008

(57) ABSTRACT

A system achieves clock synchronization in a server that includes multiple network interface cards (NICs), each having an independent hardware clock. The system determines timestamps for packet transmission and reception using a plurality of NICs and a system clock within the server. The synchronization controller of the server measures a time offset and frequency drift for each NIC hardware clock relative to the system clock and computes correction signals to align both phase and frequency. The correction signals are applied through clock-correction interfaces of the NICs to synchronize each follower NIC clock to the system clock reference. Once synchronization is achieved, all NIC hardware clocks operate coherently with the system clock, enabling the server to generate timestamps for packet transmission and reception based on unified clock values. This ensures consistent timing accuracy across all bonded network interfaces and allows the server to function as if driven by a single coherent time source.

### CROSS REFERENCE TO RELATED APPLICATION

This application claims the benefit of U.S. Provisional Application No. 63/780,052, filed on Mar. 28, 2025, which is hereby incorporated by reference herein in its entirety for all purposes.

### TECHNICAL FIELD

This disclosure relates generally to clock synchronization in networked computer systems, and more particularly to techniques for clock synchronization in servers that include multiple bonded network interface cards (NICs).

### BACKGROUND

Clock synchronization accuracy between machines in networked environments such as data centers imposes practical limitations in many time-sensitive applications. For example, synchronization discrepancies can affect distributed databases, blockchain systems, transaction tracing, snapshotting services, and high-speed mobile networks such as 5G, where jitter or clock misalignment can cause biased processing, inefficient communication, or corrupted event ordering. Traditional approaches often rely on specialized, high-cost hardware components deployed throughout the network to counter random transmission delays, component noise, and environmental variations. A specific synchronization problem occurs in servers equipped with bonded NICs (also referred to as teamed NICs). Bonded NICs refers to multiple NICs that are linked together to operate as a single logical interface, thereby increasing total network bandwidth, providing load balancing for traffic, and improving fault tolerance. In such a configuration, data packets may be distributed across the bonded NICs, but each NIC retains its own independent hardware clock, which can lead to synchronization discrepancies. When data packets are transmitted via one NIC and received via another, timestamps are taken from different, unsynchronized clocks. This may result in timing errors that disrupt coordinated communications across machines.

### SUMMARY

Systems and methods are disclosed herein that enable clock synchronization within a server that includes multiple bonded network interface cards (NICs), each having an independent hardware clock. The server maintains unified timing across all NICs so that packet timestamps taken from any interface are consistent and derived from a single coherent time source. This enables standard network time-offset estimations and ensures accurate synchronization between servers operating in a network. According to an embodiment, the system selects one clock associated with a first NIC as the primary clock and designates the clocks of the remaining NICs as follower clocks. The system performs a synchronization process for each follower clock in relation to the primary clock. During this process, the synchronization controller performs one or more offset measurements to quantify time differences between each follower clock and the primary reference. Based on the measured data, the system determines the time offset and frequency drift that characterize how each follower clock deviates from the primary clock. Using these calculated differences, the synchronization controller applies correction signals to the follower clocks through corresponding clock-control interfaces, thereby aligning both phase and frequency to the primary reference. Once the synchronization is complete, all NIC clocks operate in coordination and effectively behave as a single time source. The system determines and generates timestamps for packet transmission and reception for all NICs using the synchronized clock values. These unified timestamps guarantee accurate timing across all bonded NICs, enhance system reliability, and enable precise offset estimation between servers participating in network communication.

According to an embodiment, the server includes a system clock, and all NIC clocks are synchronized with the system clock such that timestamps for packet transmission and reception across bonded interfaces remain consistent. The server measures a time offset and a frequency drift for each NIC clock relative to the system clock. Based on these measurements, the system computes correction signals that represent the adjustments required to align each NIC hardware clock with the system reference. The synchronization controller applies these correction signals through each NIC's clock-correction interface, thereby tuning the clock's phase and frequency to minimize deviation. As a result, all follower NIC clocks remain synchronized with the system clock within a specified tolerance. Once synchronization is achieved, the server generates timestamps for packet transmission and reception across all network interfaces using the synchronized clocks. Because every NIC operates within the same unified time domain, the timestamps are coherent and interchangeable regardless of which interface processes the packet. This allows the server to perform precise network operations and time-offset estimations across servers.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

Figure (FIG.) 1 illustrates a network environment for implementing clock synchronization, in accordance with an embodiment.

FIG. 2 shows the system architecture of the machine, in accordance with one or more embodiments.

FIG. 3 shows the system architecture of the network interface card (NIC), in accordance with one or more embodiments.

FIG. 4 is a data flow diagram for correcting clock frequency and/or offset across machines, in accordance with one or more embodiments that incorporate multiple bonded network interface cards (NICs) per machine, in accordance with one or more embodiments.

FIG. 5 illustrates a process for maintaining accurate clock synchronization in a server that includes multiple bonded network interface cards (NICs), each equipped with a distinct hardware clock, in accordance with one or more embodiments.

FIG. 6 illustrates a process for maintaining clock synchronization in a server having a plurality of bonded network interface cards (NICs), where each NIC includes a distinct hardware clock, in accordance with one or more embodiments.

FIG. 7 illustrates a process executed by an adaptive control loop that refines clock-correction signals applied to the bonded network interface cards (NICs) of a server, in accordance with one or more embodiments.

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

Clock synchronization is performed across servers that possess a single network interface card (NIC). The NIC includes a hardware clock that can provide timestamps for all network operations. Modern high-performance systems include multiple NICs that are bonded to increase bandwidth, improve redundancy, and balance traffic loads. When packets are transmitted or received through different NICs, timestamps originate from different hardware clocks, breaking the single-clock assumption that underlies standard time-offset estimations. The resulting inconsistency can lead to network timing errors, inaccurate latency measurements, and misaligned event ordering across servers.

The system as disclosed addresses this issue by synchronizing clocks of multiple bonded NICs to a single source. According to an embodiment, one NIC clock is designated as the primary reference clock, and all other NIC clocks are synchronized to it. In another embodiment, a system clock of the server is designated as a primary references clock and multiple clocks of bonded NICs are synchronized with the system clock. Synchronization occurs through periodic measurement of time offset and frequency drift and the application of corresponding correction signals to each follower NIC clock. These corrections adapt over time based on environmental or operational factors that influence oscillator stability, such as temperature changes or vibration. As a result, all NICs within the bonded group behave as if they share a single coherent clock source.

The techniques disclosed allow synchronization across servers and maintaining consistent timestamping for packets transmitted or received through any interface. By synchronizing multiple NIC clocks to a unified reference, servers achieve accurate and reliable time consistency across bonded interfaces, enabling precise latency measurement, event ordering, and fair transaction processing. The system enables unified behavior among multiple NIC clocks, improving overall network precision and improved time accuracy for network packets.

### System Environment

Figure (FIG.) 1 illustrates a network environment for implementing clock synchronization, in accordance with an embodiment. Network 100 includes machines 110, which may be physical or virtual servers deployed in a data-center or cloud environment. The term “machine” refers to any device that maintains a clock or produces timestamps, such as a physical or virtual machine, a server, a server blade, a virtual machine, and the like. Each of machines 110 includes a local clock (e.g., as implemented in a computer processing unit (CPU) of a machine, or as implemented in a device that is operably coupled to a machine, such as a network interface card (NIC) of a machine). A machine 110 may include one or more bonded network interface cards (NICs), for example, NIC_A1, NIC_A2, each NIC having its own independent hardware clock (C_A1, C_A2). These NICs may operate together to provide higher bandwidth, redundancy, or load balancing. However, each NIC maintains a separate clock and timestamps obtained via different NICs may reflect different clock sources.

As depicted, network 100 is a mesh network, where each machine 110 is linked to each other machine 110 by way of one or more links (some links omitted for clarity). However, network 100 may be any other type of network. For example, network 100 may be a network where machines are serially connected on a wire, or may be in any other configuration. The network may be a large network spanning multiple physical regions (e.g., New York to San Francisco), or a small network, such as a network within a single server blade. In an embodiment, network 100 may be a network of clocks on one or more printed circuit boards.

The communication links between any pair of machines are represented as an edge 120 between the nodes in the graph. Each edge 120 typically represents multiple paths between any two machines 110. For example, the network 100 may include many additional nodes other than the machines 110 that are shown, so that there may be multiple different paths through different nodes between any pair of machines 110.

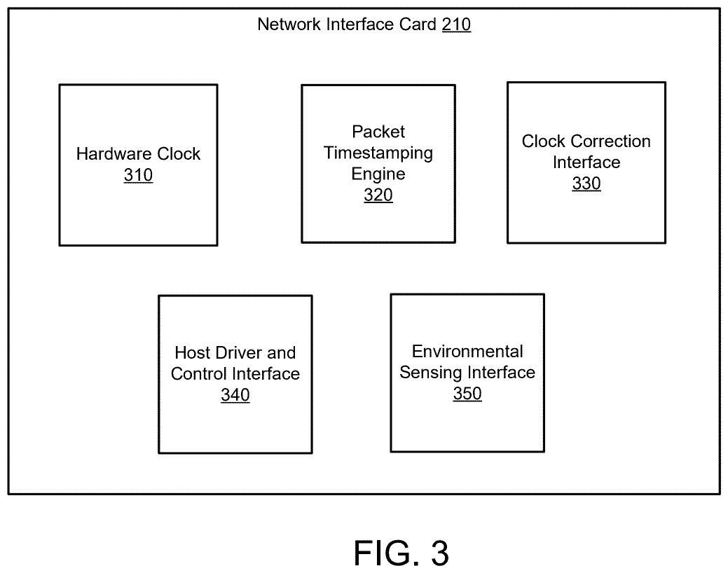

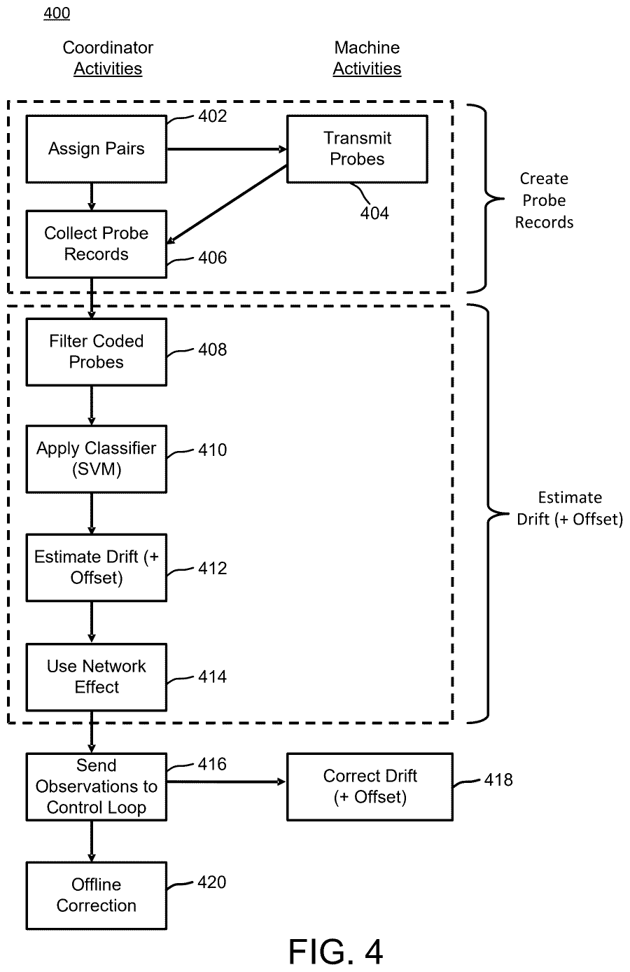

Network 100 additionally includes coordinator 130 and reference clock 140. In this example, coordinator 130 commands machines 110 to obtain network observations by probing other machines 110, as will be described in greater detail below with respect to FIG. 3. Coordinator 130 may store, or cause to be stored, records of those network observations, as will be described in greater detail below with respect to FIG. 4. Coordinator 130 may additionally transmit control signals to machines 110. The term control signal, as used herein, may refer to a signal indicating that the frequency of a local clock of a machine is to be adjusted by a specified amount (thus correcting a drift of the local clock), and may also refer to a signal indicating that a time indicated by a local clock a machine is to be adjusted by a specified amount (thus correcting an offset of the local clock).

In an embodiment, coordinator 130 stores, either within a machine housing the coordinator 130 or within one or more machines of network 100, a graph that maps the topology of network 100. The graph may include a data structure that maps connections between machines of network 100. For example, the graph may map both direct connections between machines (e.g., machines that are next hops from one another, either physically or logically), as well as indirect connections between machines (e.g., each multi-hop path that can be taken for a communication, such as a probe, to traverse from one machine to another). The graph may additionally include network observations corresponding to each edge in the graph (e.g., indicating probe transit times for probes that crossed the edge, and/or additional information, such as information depicted in FIG. 4).

One of the machines contains a reference clock 140 for the system. Reference clock 140 is a clock to which the clocks within the machines of network 100 are to be synchronized. In an embodiment, reference clock 140 is a highly calibrated clock that is not subject to drift, which is contained in a machine 110 that is different than the other machines to be synchronized. In another embodiment, reference clock 140 may be an off-the-shelf local clock already existing in a machine 110 that will act as a master reference for the other machines 110, irrespective of whether reference clock 140 is a highly tuned clock that is accurate to “absolute time” as may be determined by an atomic clock or some other highly precise source clock. In such scenarios, coordinator 130 may select which machine 110 will act as the master reference arbitrarily, or may assign the reference machine based on input from an administrator. The reference clock may be a time source, such as a global positioning system (GPS) clock, a precision time protocol (PTP) Grandmaster clock, an atomic clock, or the like, in embodiments where the reference clock 140 is accurate to “absolute time.” By signaling corrections to frequency and/or offset based on reference clock 140, coordinator 130 achieves high-precision synchronization of the local clocks of machines 110 to the reference clock 140. The terms server and machines may be used interchangeably herein.

Coordinator 130 may be implemented in a stand-alone server, may be implemented within one or more of machines 110, or may have its functionality distributed across two or more machines 130 and/or a standalone server. Coordinator 130 may be accessible by way of a link 120 in network 100, or by way of a link to a machine or server housing coordinator 130 outside of network 100. Reference clock 140 may be implemented within coordinator 130, or may be implemented as a separate entity into any of machines 110, a standalone server within network 100, or a server or machine outside of network 100.

### System Architecture

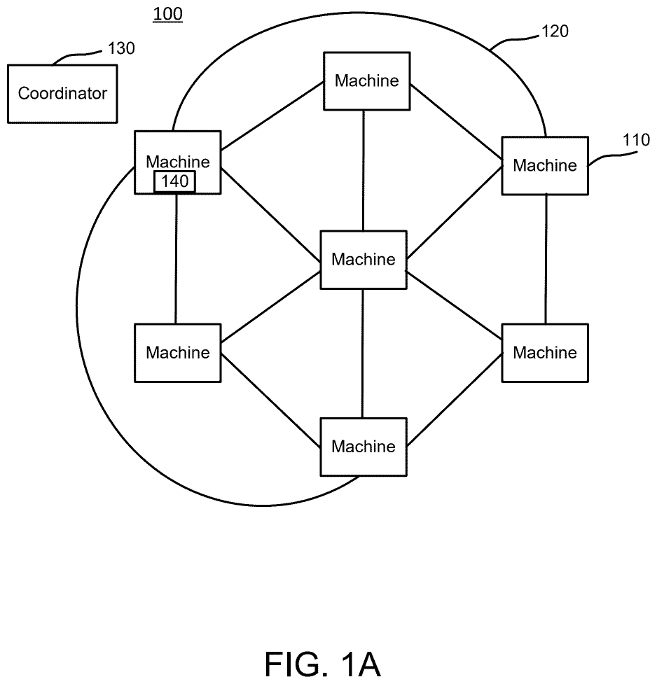

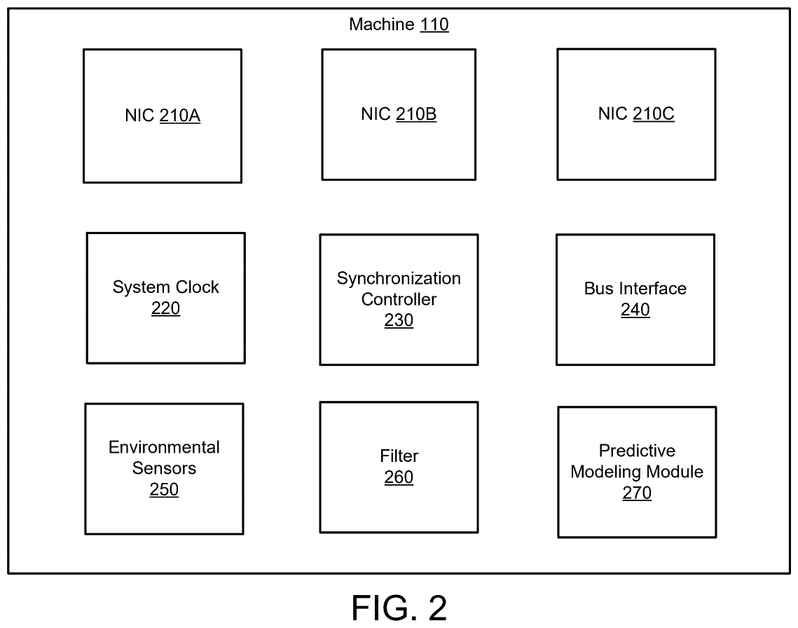

FIG. 2 shows the system architecture of the machine 110, in accordance with one or more embodiments. As shown in FIG. 2, the machine 110 includes one or more network interface cards (NICs) 210, a system clock 220, a synchronization controller 230, bus interfaces 240, environmental sensors 250, filter 260, and a predictive modeling module 270. In some embodiments, additional or alternative components to those shown in FIG. 2 may be included in the machine 110. Each module is described in detail next.

The network interface cards 210 provide high-speed communication links for transmitting and receiving data packets and perform timestamp generation for data packets being communicated. Each NIC can include its own physical hardware clock, used to mark the time that packets are sent (TX) or received (RX). Because multiple NICs 210A, 210B, and 210C may be bonded together to act as one logical interface, their independent clocks must be synchronized to ensure consistency of timestamps across interfaces. In one embodiment, a primary clock is selected among the NICs, and follower clocks are adjusted to track that primary clock by continuously applying offset and frequency corrections. In other embodiments, the NIC clocks may all be synchronized to a system-level clock external to the bonded group. The NIC modules interact with the synchronization controller 230 through the bus interfaces 240 to provide timestamp data and to receive correction commands that align their local clocks to the reference time source.

The system clock 220 provides a reference used for timekeeping by the operating system and applications running on the server. In certain embodiments, the system clock 220 acts as the master reference against which all NIC hardware clocks are synchronized. This architecture allows uniform time measurements across all bonded interfaces and ensures that timestamps generated from any NIC reflect the same system time. The system clock 220 may be implemented as part of the CPU or chipset oscillator and may use frequency-locking circuitry or software synchronization protocols such as precision time protocol (PTP) to maintain correlation between system-level and network-level time domains. In alternate embodiments, the system clock 220 may itself be synchronized to an external clock reference, such as a grandmaster or GPS source, while continuing to serve as the local reference for all NICs within the machine 110.

The synchronization controller 230 coordinates and manages the timing relationship between all clocks within the machine 110. Implemented as software executing on the CPU or as dedicated firmware, the synchronization controller 230 selects the primary clock, performs offset and drift measurements between the primary clock and the follower clocks, computes regression estimates for clock correction, and transmits control signals to adjust follower clock frequencies and offsets. The synchronization controller 230 may maintain a synchronization loop that executes periodically. The frequency of the feedback loop may be adaptively determined based on environmental feedback such as temperature stability or vibration detected by the sensors 250. In one embodiment, the synchronization controller 230 integrates sampling and regression techniques to achieve high-accuracy drift estimation with a limited number of samples while maintaining low latency in clock correction cycles. The synchronization controller 230 enables multiple NICs to act as if they share a single clock.

In an embodiment, the environmental sensing interfaces 250 and the synchronization controller 230 cooperate to monitor operating conditions that influence clock performance and determine synchronization timing accordingly. The environmental sensing interfaces 250 periodically sample temperature data from on-board thermal sensors installed on each network interface card 210 to detect conditions that may accelerate oscillator drift in the hardware clocks 310. At the same time, the environmental sensing interfaces 250 acquire vibration data from chassis-level accelerometers or other mechanical disturbance sensors to identify variations that could affect clock stability. To further refine clock behavior modeling, the environmental sensing interfaces 250 integrate airflow and humidity readings received from external facility management systems, which may reveal indirect changes in temperature around the NIC assemblies and their oscillators. All collected environmental telemetry is transmitted to the synchronization controller 230 for adaptive processing.

The synchronization controller 230 determines an appropriate synchronization interval using these environmental inputs and predefined stability thresholds. When temperature or vibration metrics exceed preset limits, the synchronization controller 230 increases the frequency of local synchronization operations to prevent significant drift accumulation. In stable conditions, the controller 230 lengthens the measurement interval to gather more offset samples and enhance regression accuracy. Offset measurements between the primary clock and the follower clocks are performed at different times throughout each interval by the synchronization controller 230 to maximize the precision of both time offset and frequency drift estimation using a linear regression model. The synchronization controller 230 selects an interval duration that balances estimation accuracy against responsiveness to rapid primary-clock frequency variations detected from environmental changes, thereby maintaining coordination among all NIC hardware clocks within the server.

The bus interfaces 240 provide the physical and logical communication channels that link the synchronization controller 230 to the individual NICs 210. Examples of such interfaces include PCI Express (PCIe), Ethernet management buses, or other high-speed interconnect protocols. Through these interfaces, the controller exchanges timestamp information, retrieves clock status registers, and sends offset and frequency correction commands to each NIC. The bus interfaces 240 may convey environmental telemetry from the NICs to the synchronization controller 230, enabling coordinated timing adjustments and diagnostics.

The environmental sensors 250 monitor operational conditions that may influence clock stability, such as temperature fluctuations, mechanical vibration, airflow, or humidity changes. Data from the sensors 250 is processed by the synchronization controller 230 to adjust the synchronization interval dynamically, balancing clock-correction precision against responsiveness to environmental disturbances. In one embodiment, the sensors 250 reside within the NIC modules, providing localized thermal readings near clock oscillators. In alternate embodiments, the sensors 250 are distributed throughout the machine chassis to capture overall ambient conditions affecting all NICs. The environmental sensor data may be exported through telemetry interfaces to an external management system, enabling remote monitoring and calibration of synchronization performance across multiple machines.

The filter 260 reduces noise in the drift and offset estimations and, extrapolates the natural progression of the clock. Filter 260 may be a predefined filter (e.g., a Kalman filter), a filter selected from an adaptive filter bank based on observations, a machine learning model, etc. According to an embodiment, the filter 260 includes an adaptive filter bank comprising a collection of candidate filters, each of which is best suited to remove noise from signals based on the type and degree of noise. For example, some noise can be observed, such as the network observations (e.g., queuing delays, effect of network operation, loop errors, etc.). Some noise, however, is inherent in the state of the machines (e.g., noise variations in response to control input across different makes and models of equipment). Noise that is unknown is referred to herein as state noise. According to an embodiment, filter 260 includes a bank of candidate filters (also referred to herein as an adaptive filter bank), which may be Kalman filters. Each of candidate filters corresponds to a different level of state noise. Filter 260 selects a filter from the candidate filters by calculating a probability for each candidate filter being a best fit, and by selecting the candidate filter with the best fit. Initially, filter 260 receives observed noise, and uses the observed noise to select a highest probability candidate filter, which is used to filter the estimated drift and offset, and output the filtered drift and offset to the synchronization controller 230. Using adaptive stochastic control, the filter 260 may find that all filters are equally likely, and may select a filter arbitrarily. After selecting a filter and observing how target clock reacts to a control signal, filter 260 adjusts the likelihood that each candidate filter best applies. Thus, as the control signal and further information about the network observations are fed into filter 260 over time, the selection of an appropriate candidate filter eventually converges to a best matching candidate filter.

FIG. 3 shows the system architecture of the network interface card (NIC) 210, in accordance with one or more embodiments. As shown in FIG. 3, the NIC 210 includes a hardware clock 310, a packet timestamping engine 320, a clock correction interface 330, a host driver and control interface 340, and environmental sensing interfaces 350. In some embodiments, additional or alternative components to those shown in FIG. 3 may be included in the NIC 210. Each module is described in detail next.

The hardware clock 310 provides the fundamental timing source for the NIC and is responsible for maintaining precise internal time, typically based on a physical hardware oscillator or a precision hardware clock (PHC). The hardware clock 310 generates clock cycles that define timestamping and temporal operations of the NIC. In some embodiments, the hardware clock 310 integrates a quartz or temperature-compensated crystal oscillator, while in others it may use advanced clocking technologies such as MEMS or atomic references for improved stability. Each NIC may have its own independent hardware clock, and when multiple NICs are bonded, the independence of these clocks requires synchronization to maintain timestamp consistency. In various embodiments, one hardware clock 310 acts as a primary reference for the bonded group, and follower NIC hardware clocks are continuously synchronized to it or to a system-level clock through the clock correction interface 330 and host driver and control interface 340. The hardware clock 310 may also exchange control and status signals with the environmental sensing interfaces 350 to apply adaptive frequency corrections when external temperature or vibration conditions vary.

The packet timestamping engine 320 records the time of network packet transmission (TX) and reception (RX) events as packets pass through the NIC. It relies directly on the hardware clock 310 to generate timestamps, storing these values with associated packet metadata so that higher-level network synchronization mechanisms can accurately measure latency and offset. In one embodiment, the packet timestamping engine 320 operates in compliance with IEEE 1588 precision time protocol (PTP) standards, which include hardware-assisted packet timestamping registers. In other embodiments, the packet timestamping engine 320 may be implemented in programmable logic such as an FPGA or ASIC to achieve near-nanosecond precision. The packet timestamping engine 320 interacts closely with the host driver and control interface 340, forwarding timestamp data for synchronization and diagnostics, and receives timing calibration inputs from the clock correction interface 330 to maintain alignment with the synchronized time source.

The clock correction interface 330 provides programmable control registers used to adjust the timing characteristics of the hardware clock 310. These registers allow fine-grained modification of clock offset (phase) and clock frequency (rate), enabling the host system or synchronization controller to compensate for drift or misalignment detected through timing analysis. In one embodiment, the clock correction interface 330 includes a set of registers for adding or subtracting time increments and for scaling frequency with parts-per-billion precision. These mechanisms allow firmware or driver commands to apply phase shifts and rate corrections without disrupting NIC data transmission. The clock correction interface 330 can receive correction values generated by the synchronization controller module within the server and apply them to the hardware clock 310 in real time. In some embodiments, the clock correction interface 330 supports atomic write operations that ensure exact timing adjustments under high-frequency synchronization cycles.

The host driver and control interface 340 serves as an interface between the NIC and the server's synchronization subsystem. It interfaces through a memory-mapped I/O (MMIO) channel or a management bus that allows reading and writing of NIC clock registers, timestamp data, and control metadata. The host driver and control interface 340 initiates synchronization cycles by requesting timing measurements, computing offset data, and applying correction commands received from a synchronization controller running on the server's CPU. In one embodiment, the host driver and control interface 340 ensures transactional integrity of clock updates using queuing and command acknowledgment mechanisms to avoid timing inconsistencies while correction signals are transmitted. In another embodiment, the interface may expose APIs or driver routines that support integration with external protocols such as PTP or Network Time Protocol (NTP). The host driver and control interface 340 therefore operates as the layer uniting physical NIC clock control mechanisms with system-level synchronization logic.

The environmental sensing interfaces 350 provide telemetry on conditions that influence clock accuracy, such as temperature, vibration, and airflow within the machine chassis. These interfaces may include integrated temperature sensors near the hardware clock oscillator or external connectors for environmental probes located on the NIC or motherboard. The environmental sensing interfaces 350 feed real-time condition data to the host driver and synchronization controller, which adjusts synchronization intervals and clock correction parameters accordingly. In one embodiment, the sensor feedback enables adaptive correction cycles that are more frequent when temperature changes rapidly and less frequent under stable conditions, thereby balancing correction accuracy with computational overhead. In other embodiments, environmental sensing interfaces 350 may combine measurements from multiple NICs to form a unified environmental profile of a server's bonded NIC cluster. This telemetry ensures clock stability under varying operational conditions and supports long-term precision for network time synchronization across all bonded NICs.

FIG. 4 is a data flow diagram for correcting clock frequency and/or offset across machines, in accordance with one or more embodiments that incorporate multiple bonded network interface cards (NICs) per machine. The left column of FIG. 4 describes activities of a coordinator (for example, coordinator 130) in achieving highly precise clock synchronization by correcting clock frequency (i.e., drift) and/or offset, while the right column describes corresponding activities of machines (for example, machines 110) that may each include a plurality of bonded NICs. FIG. 4 can be conceptualized as having three phases: a first phase in which network observations are made by having machines probe other machines of the network (for example, network 100); a second phase in which the observations are used to estimate offset and drift values for the clocks within the machines; and a third phase in which frequency and/or offset corrections are applied to achieve and maintain precise synchronization among the machines and their internal NIC clocks.

As part of the first phase, data flow 400 begins when the coordinator assigns 402 machine pairs. The term “pair,” as used herein, refers to two machines that transmit probes to one another for the purpose of collecting network observations. Each machine may include multiple bonded NICs, each having its own independent hardware clock. Accordingly, probes transmitted or received between machine pairs may traverse any of the bonded NICs and thus involve different local NIC hardware clocks. The clock synchronization process within each machine ensures that these multiple NIC clocks are first locally synchronized to a designated primary or reference clock, allowing the timestamps associated with probe transmission and reception to be treated as deriving from one coherent machine-level clock. The term “network observations” refers to measurable properties of the network such as latency, queuing delay, jitter, or observed offset and drift characteristics. The term “probe” refers to an electronic communication transmitted from one machine to another, where the transmission and reception of that communication are timestamped using the available clock sources. The timestamps may be taken by the server CPU, the operating system clock, or, more typically, by one of the NICs that are part of or operably connected to the sending and receiving machines. As will be described further below with respect to additional figures, a single machine may be paired with multiple other machines. When assigning pairs, the coordinator may select how many and which machines are paired, based on predefined parameters or dynamic evaluation of factors such as network congestion or latency. The pairings may be assigned randomly or through deterministic logic.

Data flow 400 continues when the coordinator instructs 404 the paired machines to exchange probes with one another. Each probe is timestamped upon transmission and receipt by the relevant clocking component within the sending and receiving machines. In the case of bonded NICs, these timestamps may be obtained from any of the locally synchronized NIC hardware clocks. The network observations derived from the two-way probe exchanges are collected 406 into probe records. A probe record is a structured data entry that includes the identity of the transmitting and receiving machines, the identity of the transmitting and receiving NICs where applicable, a transmit timestamp, a receive timestamp, and any other network observation information such as path ID or link quality data. Transit time for each probe may be determined by comparing the transmit and receive timestamps. While in certain embodiments the coordinator aggregates all probe records centrally, other embodiments allow each machine to maintain its own local probe record dataset for probes transmitted or received through its NICs, with local computation of offset and drift metrics.

After probe records have been collected, the coordinator enters a second phase that uses the collected data to estimate offset and/or drift for the machines and, when relevant, for clocks within the bonded NIC sets. To obtain high-accuracy estimations, the coordinator first filters 408 the probe records to identify coded probes, those unaffected by queueing delay or other forms of transient network noise. Filtering may occur both at the coordinated level and locally within the machines managing their own probe datasets. In implementations involving multiple NICs per machine, filtering may further ensure that probe records reflect timestamps already normalized to each machine's primary or system clock, thereby eliminating internal inconsistencies caused by different NIC clocks. The remaining subset of records, referred to as coded probe records, represents the most reliable data for use in clock-offset estimation and drift computation.

The coordinator applies 410 a classifier to the coded probe records. The classifier may use machine learning, such as a supervised model (for example, a support vector machine), to produce a linear fit of the probe transit-time data, yielding a slope and intercept. The coordinator uses this fit to estimate drift and offset 412 between pairs of machines. The slope of the fit represents a rate of drift while the intercept corresponds to an offset estimate. These operations can also be performed locally on each machine for its collected probe records to reduce centralized load. When multiple NICs are present, further refinement may be performed per clock pair within a machine (for example, between a NIC's hardware clock and the machine's system clock) so that both intra-machine and inter-machine clock differences are resolved consistently.

Because even coded probes may be affected by residual network noise, the coordinator compensates for any resulting errors by using 414 the network effect based on combined drift estimations across three or more machines. This step corrects estimation bias caused by network components introducing asymmetric latency or jitter between paired endpoints. The coordinator sends 416 the filtered and corrected timing observations to a control loop within each machine. In a standard system, this control loop would act upon a single local clock; in the bonded-NIC embodiment, the control loop may instead act upon a primary or system reference clock and distribute adjustments through the local intra-machine synchronization process to all NIC hardware clocks. The received data may be filtered or processed by a model that outputs an absolute drift and offset value relative to a reference clock. Having determined the absolute drift, the coordinator determines whether to correct 418 clock frequency or offset in real-time or near real-time, or alternatively perform 420 an offline correction. The choice between real-time and offline correction depends on timing noise and system load conditions.

Finally, in the third phase, frequency and offset corrections are applied and propagated. Each adjustment cycle may also include an internal synchronization stage in which the follower NIC hardware clocks within each bonded group are updated based on the newly corrected primary or system clock values. This ensures that subsequent probe timestamps from any NIC remain consistent with the machine's unified timing reference. The process 400 recurs periodically for each machine pair to compensate for natural drift or new offsets appearing after previous corrections. For example, process 400 may be executed every few seconds to maintain synchronization across all machines and across all NICs within each bonded configuration, ensuring that the entire network maintains unified clock alignment over time.

According to an embodiment, the filtering and clock adjustment may be repeated on a periodic basis (e.g., every two seconds). In an embodiment, clock offsets are estimated in the middle of the period (e.g., 1 second into a 2-second period), whereas control signals happen at the end of the period (e.g., at the 2-second mark of the 2-second period). Thus, filter 260, in addition to reducing noise in the estimate, extrapolates to output filtered offset and drift values that are accurate at the time of control. Filtered offset and drift are used by synchronization controller 230 to determine a frequency (and offset) adjustment signal to a target clock of machine 110. The target clock is a NIC clock that is being adjusted based on a reference clock. The reference clock may be a designated NIC clock or a system clock of the machine 110. The adjustment is reflective of frequency and offset value changes in target clock to remove offset and drift from the target clock. The frequency and offset adjustments are also fed back to the filter 260 as parameters for the filter, in addition to the estimated offset and drift for the filter, on a subsequent cycle of the control loop. In this control loop, the plant under control is determined by the state variables {absolute offset, absolute drift} of the local machine and an adaptive stochastic controller is used to control the plant. Adaptive stochastic control refers to adjusting control signals based on a likelihood that a given adjustment is a correct adjustment, as compared to other possible adjustments; as control signals are applied, actual adjustments are observed, and probabilities that each possible control signal will lead to a correct adjustment are adjusted.

The predictive modeling module 270 continuously analyzes environmental and clock-stability data to anticipate changes in the primary clock's timing behavior and to adjust synchronization intervals preemptively. The predictive modeling module 270 communicates with the environmental sensing interfaces 250 and receives telemetry inputs including temperature readings, vibration data, humidity, airflow, and other environmental metrics collected both from NIC-level sensors and facility-level monitoring systems. These signals are correlated with historical synchronization data retrieved through the bus interface 240 and stored locally in a learning database accessible to the synchronization controller 230. The predictive modeling module 270 processes these historical and real-time datasets to estimate potential changes in the frequency or offset of the primary clock 310a, thereby guiding adaptive control operations performed by the synchronization controller 230.

The predictive modeling module 270 executes statistical forecasting algorithms to project upcoming oscillator-stability variations before they manifest in measurable drift. In one implementation, the module 270 applies regression-based techniques or time-series forecasting models that compute expected drift coefficients based on prior correlation between temperature cycles, vibration intensity, and historical frequency changes. In another implementation, the predictive modeling module 270 performs machine-learning inference to refine its forecast accuracy. The model incorporates supervised and unsupervised learning techniques, including neural-network regressors and anomaly-detection methods, that derive predictive features from synchronization loop data and environmental telemetry. Over successive synchronization cycles, the predictive modeling module 270 updates its internal model weights by comparing predicted clock behavior to actual offset and drift values measured by the synchronization controller 230. Through such online or periodic retraining, the module continuously improves its decision accuracy for determining measurement-interval length.

The predictive modeling module 270 classifies environmental telemetry patterns into stability categories such as “stable,” “moderately unstable,” and “high drift risk.” This classification is performed through supervised machine-learning algorithms that map sensor features to predetermined stability states. Each state corresponds to a distinct synchronization strategy managed by the synchronization controller 230, for example, longer measurement intervals for stable conditions and shorter intervals for high-risk conditions. The module 270 also integrates multi-source data through a weighting engine that combines metrics from local NIC sensors and facility controllers to compute a composite drift-risk score, which reflects the overall likelihood of imminent frequency instability.

In an advanced embodiment, the predictive modeling module 270 applies stochastic or reinforcement-learning processes that enable the synchronization controller 230 to learn optimal synchronization behavior adaptively. The module monitors performance metrics such as offset-estimation accuracy, convergence latency, and energy consumption, using feedback from hardware clock adjustments to refine future control actions. Each predictive output is associated with a calculated confidence level, and the synchronization controller 230 enforces interval changes only when the predicted primary-clock variation exceeds a predefined threshold of confidence. These predictive and weighted outputs are delivered to the synchronization controller 230, which selects the next synchronization interval and correction update rate, balancing measurement accuracy with responsiveness to environmental or operational fluctuations. Through such predictive modeling and continuous learning, the system maintains nanosecond-level clock alignment across bonded NICs while reducing unnecessary corrections and adapting intelligently to changing environmental conditions.

### Processes for Clock Synchronization

The system implements processes for maintaining precise clock synchronization among multiple bonded network interface cards (NICs) within a server. The system designates one NIC's hardware clock as the primary reference and treating all remaining NIC clocks as follower clocks. Offset and drift measurements are taken over defined intervals and analyzed using regression techniques to determine correction signals. These signals are applied to align each follower clock with the primary clock while environmental data, such as temperature and vibration, are monitored to adapt interval length dynamically. This process causes all NIC clocks to synchronize with a unified timing source, enabling accurate timestamping and consistent application of standard network time-offset estimations.

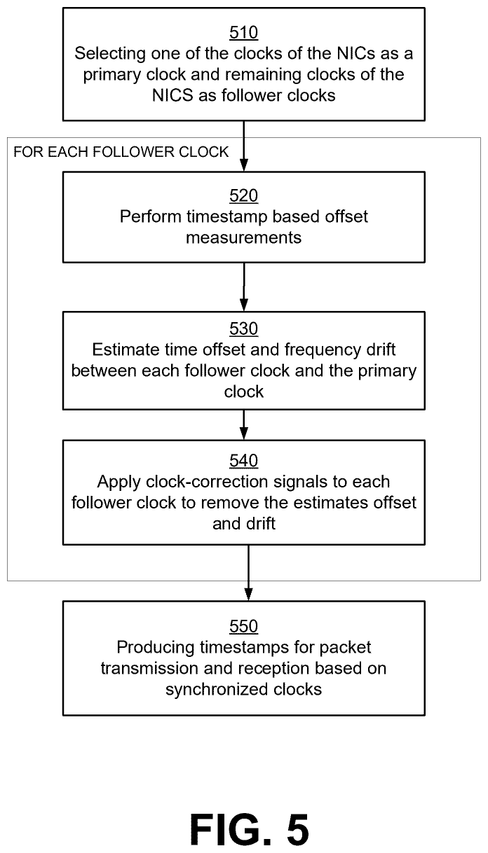

FIG. 5 illustrates a process for maintaining accurate clock synchronization in a server that includes multiple bonded network interface cards (NICs), each equipped with a distinct hardware clock. The flowchart represents how the synchronization controller 230 and related modules of the server coordinate operations across NICs to ensure consistent timestamping for all network traffic. The process begins by identifying a primary hardware clock among the bonded NICs, and iteratively performs offset measurement, drift estimation, adaptive timing control, and correction operations to align the follower clocks to the primary clock. Once synchronization is achieved, all timestamps reported by any NIC within the bonded configuration correspond to a unified time source, enabling accurate network synchronization between servers.

The synchronization controller 230 selects 510 one of the hardware clocks associated with a network interface card 210 as the primary clock. The same synchronization controller 230 designates the hardware clocks associated with the remaining NICs as follower clocks, establishing a local hierarchy in which the primary clock acts as the timing reference for the bonded group. The synchronization controller 230 initiates a synchronization routine that iteratively aligns each follower clock with the primary clock through continuous measurement, estimation, and correction steps communicated via the host driver and control interface 340.

For each designated follower clock, the synchronization controller 230 performs 520 a series of offset measurements between the follower clock and the primary clock over a defined measurement interval. The packet timestamping engine 320 of each NIC 210 generates transmission and reception timestamp samples spaced apart within this interval, allowing both short-term and long-term variations in offset and frequency to be captured. The synchronization controller 230 retrieves these timestamp samples through the bus interface 240 and processes them to estimate clock parameters. The offset samples are intentionally spaced within the interval to make them suitable for analysis by a linear regression model that can reveal both instantaneous time offset and long-term clock drift trends.

The synchronization controller 230 estimates 530 the time offset and frequency drift between each follower clock and the primary clock. A regression analysis engine within the synchronization controller, or an associated processing module, fits the timestamp data to a linear model; the slope of the fit corresponds to clock drift, while the intercept represents the misalignment or offset. These values are transmitted to the clock correction interface 330 of each NIC, where the follower clock's oscillator parameters are prepared for fine-grained correction. During this phase, the synchronization controller 230 also adaptively determines the length of the measurement interval to balance precision against responsiveness. Environmental sensing interfaces 250 monitor factors like temperature and vibration that affect clock stability, and the synchronization controller 230 adjusts the synchronization interval accordingly, lengthening it during stable operation for better estimation accuracy, and shortening it under unstable conditions to respond promptly to changes.

The synchronization controller 230 applies 540 clock-correction signals to each follower NIC clock based on the estimated offset and drift values. Through the NIC's clock correction interface 330, small modifications are made to the clock phase and frequency to bring the follower clock into alignment with the primary clock. The controller verifies correction effectiveness by reading updated clock values from the hardware clock 310 and feeding new offset data into subsequent synchronization cycles, ensuring continuous convergence of all clocks toward the reference behavior of the primary clock. This feedback process maintains tight alignment between all bonded NICs, despite variations in environmental or operational conditions.

The packet timestamping engine 320 produces 550 timestamps for packet transmission and reception using the unified clock domain established across all NICs. Because each follower clock now tracks the primary clock within nanosecond precision, every timestamp captured by any NIC 210 corresponds to the same logical time base. This configuration allows the server to apply standard two-way network time-offset estimation formulas normally used for synchronization between servers, treating the bonded NIC cluster as a single, coherent clock source. The result is consistent, high-accuracy network timing suitable for distributed computing or any application requiring precise synchronization of packet events.

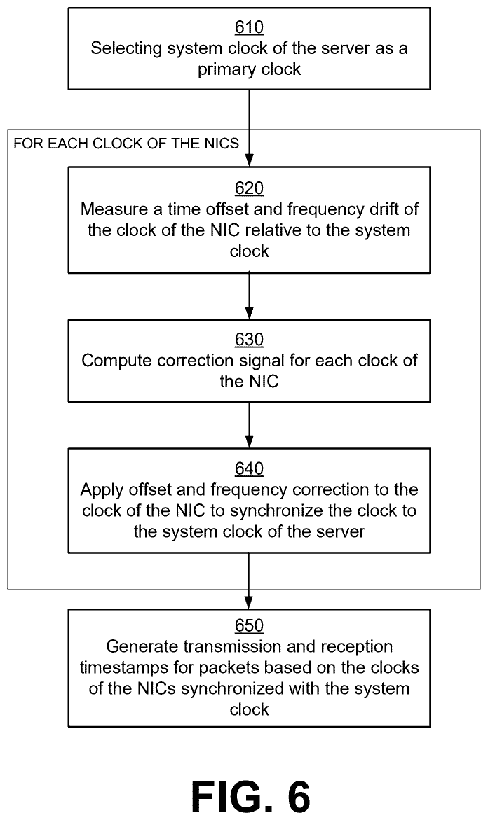

FIG. 6 illustrates a process for maintaining clock synchronization in a server having a plurality of bonded network interface cards (NICs), where each NIC includes a distinct hardware clock. The flowchart shows the sequence of operations performed by the modules of the system architecture, specifically, the synchronization controller 230, clock correction interface 330, hardware clock 310 of each NIC 210, bus interface 240, and packet timestamping engine 320. The process uses a system clock 220 distinct from the NIC hardware clocks as a unified reference for the entire bonded configuration, ensuring that timestamps generated across different NICs are consistent and derived from a single coherent time source.

The synchronization controller 230 selects 610 the system clock 220 as the reference clock for the server. This establishes a common time base that provides absolute synchronization for all NIC hardware clocks 310. The synchronization controller 230 initializes periodic synchronization cycles and coordinates interactions between the system clock 220 and the various NIC clocks through the bus interface 240, defining parameters for measurement intervals and correction precision.

During each synchronization cycle, the synchronization controller 230 measures 620, for each NIC hardware clock 310, the time offset and frequency drift relative to the system clock 220. The host driver and control interface 340 retrieves timestamp samples from each NIC to assess differences in phase and frequency. The measurements may be taken at regular intervals, such as every few milliseconds or seconds depending on the stability of the clocks, and represent how far each hardware clock has drifted in relation to the system reference.

In an embodiment, the synchronization controller 230 performs offset measurements between the primary clock and each follower clock that are intentionally spaced within a defined measurement interval to optimize estimation accuracy for both time offset and clock drift. The synchronization controller 230 coordinates sampling activity through the host driver and control interface 340, which retrieves timestamps from each hardware clock 310 of the network interface cards 210. Each measurement sample is taken at predetermined or adaptively calculated time positions within the interval to ensure sufficient temporal distribution of data points for regression analysis. Once the spaced samples are collected, the synchronization controller 230 executes a linear regression model that fits the measured offset values across the interval, where the slope of the regression line represents the frequency drift between the follower clock and the primary clock and the intercept defines the real-time offset. By spacing measurements in this manner, the synchronization controller 230 minimizes sampling noise and enhances estimation accuracy while maintaining a sufficiently short interval to respond to clock variations caused by environmental conditions detected through sensors 250. The resulting regression outputs are used to compute correction signals applied via the clock-correction interface 330 to align each follower clock with the primary reference, achieving a unified timing domain for packet timestamp synchronization.

The synchronization controller 230 computes 630 correction values for each NIC hardware clock based on the observed offset and drift. In this step, the controller may employ a regression or filtering algorithm to reduce measurement noise and to generate estimations that are predictive of true clock deviation. For example, a linear regression model or a Kalman filter may be used to combine current and previous offset measurements, producing smooth correction values that account for both instantaneous and long-term drift behavior. These computed correction signals are formulated to adjust the NIC oscillator rate and phase within predefined error tolerance limits.

Using the computed control signals, the synchronization controller 230 applies 640 offset and frequency corrections to each NIC hardware clock 310 via the clock correction interface 330. The interface writes adjustment values to the registers of each NIC to advance or retard the clock phase and slightly increase or decrease oscillator frequency so that the follower clocks converge toward the system clock 220. The synchronization controller 230 verifies the updated clock states by reading new timing values through the host driver 340, confirming that each adjusted clock remains synchronized within the predetermined tolerance. The environmental sensors 250 may provide real-time operating conditions, such as temperature and vibration, that influence oscillator behavior; the synchronization controller 230 uses this data to refine correction magnitude or update frequency as needed for continued stability.

After synchronization corrections have been successfully applied, each packet timestamping engine 320 generates 650 transmission and reception timestamps based on the synchronized clock values. Because all NIC clocks 310 now track the system clock 220 precisely, packet timestamps taken by any bonded NIC are coherent and interchangeable. The bonded NICs therefore function as a unified timing domain, enabling accurate latency measurements, consistent event ordering, and the reliable application of two-way network time-offset estimation formulas between servers. As a result, the entire server operates as if driven by a single master clock, delivering high-precision synchronization across all network interfaces without additional hardware or protocol modification.

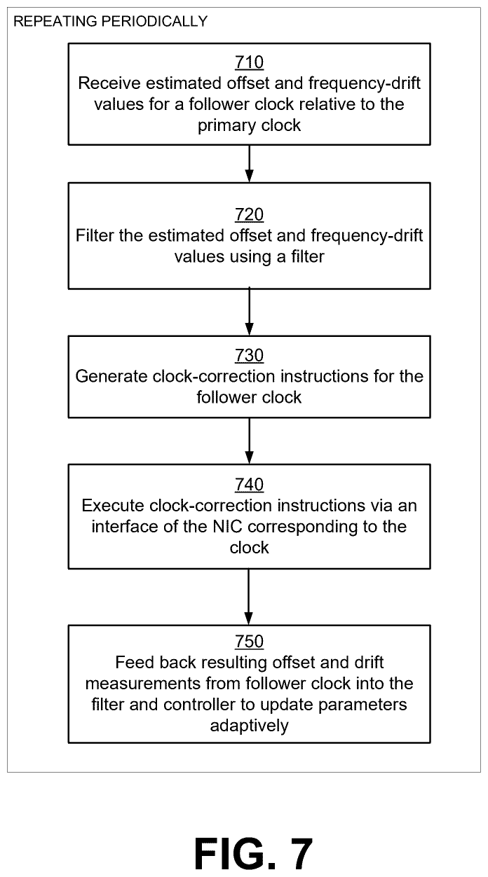

FIG. 7 illustrates a process executed by an adaptive control loop that refines clock-correction signals applied to the bonded network interface cards (NICs) of a server. The flowchart depicts how the synchronization controller 230, operating through the NIC clock-correction interfaces 330 and associated filtering and control modules, continuously updates the follower NIC clocks to minimize offset and frequency drift relative to the primary clock. The process includes receiving offset and drift data, filtering those data using predictive or adaptive algorithms such as a Kalman filter, deriving clock-correction commands using a controller, applying those corrections through each NIC interface, and feeding resulting measurements back to the filter and controller for ongoing adaptive adjustment. This closed-loop approach ensures convergence of all follower clocks toward the primary reference with high precision and stability over time.

The synchronization controller 230 receives 710 estimated offset and frequency-drift values for each follower NIC clock relative to the primary clock. These estimates are obtained from timestamp measurements collected by the packet timestamping engines 320 of the NICs 210 and transmitted through the bus interfaces 240 to the synchronization controller 230. The incoming values describe the degree of clock misalignment and the rate of frequency change since the previous synchronization cycle.

The synchronization controller 230 filters 720 the estimated offset and drift values using a noise-reduction or predictive filter. The filtering module 560 applies algorithms such as a Kalman filter or an adaptive filter designed to suppress measurement noise caused by network delays or environmental fluctuations. This filter executes a prediction step modeling the expected clock behavior based on prior measurements, and updates the state using new measurement data collected in the current cycle. The filtering module 560 computes correction gains to minimize estimation errors and outputs 730 filtered offset and drift parameters representative of each follower-to-primary clock state. The filter may select between multiple candidate filters adaptively based on observed noise characteristics, ensuring optimal accuracy under varying conditions.

Based on the filtered parameters, the controller 570 generates 730 a clock-correction command for each follower NIC hardware clock 310. The command includes quantitative instructions for adjusting both clock phase (offset) and frequency (rate of ticking) to counter deviations from the primary clock 310 or the system clock 220. The controller 570 executes 740 these clock-correction commands through the NIC clock-correction interface 330. The correction interface 330 writes new timing values or frequency-scaling parameters directly to registers controlling the follower hardware clocks, thereby synchronizing the follower clocks within nanosecond precision to the primary reference.

After each correction cycle, the synchronization controller 230 feeds back 750 resulting offset and drift measurements from the follower clocks into both the filtering module 560 and controller 570. This feedback loop enables continuous adaptation of filter and controller parameters, allowing subsequent correction signals to be refined as the system learns each clock's response behavior over time. The process repeats periodically, enabling the adaptive control loop to converge toward minimum offset and drift between the primary and follower clocks and maintaining synchronized performance for all network interfaces in the bonded configuration.

Accordingly, the server ensures that every packet timestamp produced by any NIC reflects a unified time source. The adaptive control loop compensates automatically for environmental disturbances and inherent oscillator variability, yielding a stable synchronization framework capable of nanosecond-level accuracy using standard hardware components.

In an embodiment, the synchronization controller 230 performs two-way network time-offset estimation between the server and one or more remote servers. The synchronization controller 230 obtains transmission and reception timestamps for network packets exchanged between the local server and each remote server using the packet timestamping engines 320 of the bonded NICs 210. Because the clocks of the plural NICs have been synchronized to a unified reference, either the primary NIC clock or the system clock 220, the synchronization controller 230 uses 912 the timestamps derived from these synchronized clocks to execute a standard two-way offset estimation formula, calculating the difference between local and remote time sources with high accuracy. The computed offset values correspond to the propagation delay and clock difference between the servers, independent of which NIC handled the packet transfer. The synchronization controller 230 records the offset estimations and, where required, transmits compensation commands to the corresponding NICs 210 through the clock-correction interfaces 330 to maintain continuous alignment between local and remote server clocks. This operation ensures that all servers participating in network communication operate on unified time sources, enabling accurate and reliable determination of network offsets for precision-timing and high-consistency data-exchange applications.

In an embodiment, the synchronization controller 230 propagates corrections to each follower clock responsive to detecting a correction applied to the primary clock during system-level synchronization. The synchronization controller 230 monitors the primary clock associated with one of the network interface cards 210 or the system clock 220 to determine when an external synchronization operation, such as adjustment to the reference time or frequency, has occurred. Upon detecting a change, the synchronization controller 230 calculates corresponding offset and frequency correction parameters that mirror the modification made to the primary clock. The synchronization controller 230 transmits these correction signals through the bus interface 240 to each follower NIC clock 310 via its clock-correction interface 330. Each follower clock 310 applies the received correction to its internal oscillator registers, updating both phase and frequency so that all NIC hardware clocks reflect the same system-level change applied to the primary reference. This propagation maintains consistent absolute timing across every network interface of the server and ensures that packet transmission and reception timestamps generated by the packet-timestamping engines 320 remain uniform, regardless of which NIC handles network traffic. As a result, the bonded NIC configuration continues to operate as if driven by one coherent time source, preserving synchronization integrity both within the server and across connected systems.

In an embodiment, the synchronization controller 230 operates an adaptive control loop that includes stochastic and machine-learning algorithms configured to predict the next offset and drift state of each follower clock, thereby minimizing deviation between the follower clocks and the primary clock over successive update intervals. The machine-learning submodule of the controller 570 receives input vectors that include measured data from the previous synchronization cycles, such as time offset, frequency drift, environmental measurements from the environmental sensors 250, temperature and vibration telemetry, and correction history applied through the clock-correction interfaces 330. Additional inputs may include prediction residuals from the filtering module 560 and statistical variances estimated from historical measurements to describe the stability of each follower hardware clock 310.

The controller 570 processes these inputs using a predictive learning model, such as a recurrent neural network, regression neural network, or reinforcement learning agent, to forecast the next offset and drift values for each follower clock in the upcoming synchronization interval. The predictive model outputs the predicted offset and drift parameters and a corresponding control signal specifying adjustment values to be applied to each follower clock. These output signals are transmitted via the bus interface 240 to the clock-correction interface 330 of each NIC 210, which updates the oscillator phase and frequency accordingly, keeping all clocks closely aligned to the primary timing reference.

The machine-learning model may be trained by the synchronization controller 230 using historical synchronization data collected across multiple operating intervals. Training data can be obtained from the timestamping engine 320 and the environmental sensors 250, providing correlations between temperature or vibration changes and resulting offset drift behavior in each hardware clock 310. In some configurations, the controller 570 performs ongoing online learning, continuously updating model parameters as new synchronization cycles are executed and measured errors between predicted and actual offset and drift values are evaluated. In other configurations, training may occur offline using network simulation data or archived logs of operational measurements recorded under various workloads and environmental conditions. Through iterative training and prediction, the machine-learning model converges toward control outputs that minimize long-term synchronization error, thereby improving predictive accuracy and maintaining high-fidelity time alignment among all bonded NIC clocks within the server.

### Alternative Embodiments

In an adaptive embodiment, the synchronization controller 230 adjusts 710 the length of a measurement interval or correction update rate in response to changes in environmental and clock-stability parameters associated with the primary clock. The synchronization controller 230 receives real-time telemetry from the environmental sensors 250, which monitor operational conditions such as temperature, vibration amplitude, airflow, and component stress within the chassis. These values are analyzed together with internal indicators of clock stability, such as frequency noise or fluctuation metrics derived from the hardware clock 310. Based on this analysis, the synchronization controller 230 dynamically modifies 712 the duration of measurement intervals used for offset sampling or the frequency at which correction commands are issued to the follower clocks through the clock correction interfaces 330. When temperature or vibration levels increase, or other conditions cause higher frequency noise, shorter intervals and higher correction rates are applied to allow faster compensation for rapid clock variation. Conversely, under stable ambient and operating conditions, the synchronization controller 230 lengthens 714 the measurement interval to collect additional timestamp data and improve regression-based estimation accuracy for offset and drift. By balancing interval duration and update rate adaptively, the synchronization controller 230 maintains optimum synchronization between all NIC hardware clocks 310 and the primary reference clock which may be the system clock or a selected NIC hardware clock, thereby achieving efficient alignment.

### Technical Improvements

The techniques disclosed herein synchronize the clocks of a server and address several issues caused by desynchronization of clocks of a server. Desynchronized network interface card (NIC) clocks in a bonded NIC configuration can lead to several significant network difficulties. In this setup, each NIC maintains its own independent hardware clock, and as packets are transmitted and received through different interfaces, the associated timestamps may originate from different clock sources within the same server. This condition violates the assumption inherent in the standard two-way offset estimation formula that all timestamps used for synchronization are derived from a single, consistent clock within the machine. As a result, offset calculations between servers become inaccurate, and precise network synchronization cannot be achieved. Such inconsistencies give rise to various problems in high-performance or distributed environments. Incorrect time synchronization across servers occurs because the foundational time-offset computations fail when timestamps reflect different clock domains. Event misordering frequently follows, where logs and monitoring data record occurrences out of sequence, making system analysis and troubleshooting more complicated. Performance degradation can also occur, as latency and throughput measurements become unreliable and network protocols dependent on accurate timing behave suboptimally. In addition, diagnosing network or application issues becomes more difficult because inconsistent timestamps obscure the actual sequence and timing of events. Overall, the lack of coherence among the NIC hardware clocks in bonded configurations undermines both data accuracy and operational reliability. Without unified clock synchronization, servers experience measurement discrepancies, degraded temporal alignment, and unpredictable communication performance, all of which reduce efficiency and reliability in mission-critical networked systems. The techniques disclosed herein synchronize the different clocks of the server having multiple NICs and thereby address these issues.

In both embodiments, where a NIC hardware clock acts as the primary clock and where the system clock serves as the primary reference, the system restores accurate time alignment within the server and across networked systems. When a NIC clock is selected as the primary source, synchronizing all other NIC hardware clocks to that reference enables the server to behave as if it contains a single unified timing element. Similarly, when the system clock is used as the primary, synchronizing all NIC hardware clocks to the system clock ensures that timestamps taken by any bonded interface correspond to the same coherent time domain used by the operating system and applications. In both cases, the synchronized environment reinstates the validity of standard two-way network time-offset estimation formulas, allowing precise and reliable offset measurements among servers.

The system also ensures consistent timestamping across all network interfaces, eliminating discrepancies caused by differences in clock sources among bonded NICs. Regression-based offset and drift estimation produces highly accurate synchronization with minimal noise, and adaptive interval control maintains stability by adjusting update frequency based on observed temperature, vibration, or other environmental factors. This adaptability ensures that synchronization precision is maintained even under varying operational conditions. The technique operates with minimal hardware overhead and leverages existing NIC and system-level interfaces, making it suitable for deployment on standard commercial servers. Because every NIC in a bonded configuration shares a common time reference, either the selected primary NIC clock or the system clock, failover and load-balancing events can occur without introducing timestamp discontinuities, improving reliability and supporting fault-tolerant designs.

Furthermore, unified timing data derived from the synchronized clocks enhances network-performance analytics, enabling highly precise latency and jitter measurements and facilitating efficient troubleshooting. The synchronization also ensures compatibility with standard synchronization protocols such as Precision Time Protocol (PTP) and Network Time Protocol (NTP), allowing these protocols to operate correctly in a bonded-NIC environment. Overall, the system delivers high-accuracy, adaptive clock synchronization with nanosecond-level precision while remaining cost-effective, scalable, and reliable in both NIC-based and system-clock-based embodiments.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for monitoring for anomalies in network traffic, addressing anomalies, and prioritizing network communications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of synchronizing network interface card (NIC) clocks in a server with multiple NICs, the method comprising:
performing packet transmission and reception by a server, the server comprising a system clock and plurality of NICs, each NIC including a NIC clock;
synchronizing NIC clocks of the plurality of NICS of the server with the system clock of the server, comprising, for each NIC clock:
determining a time offset and a frequency drift of the NIC clock with respect to the system clock,
determining correction signals for correcting the time offset and the frequency drift of the NIC clock, and
synchronizing the NIC clock with the system clock by applying the correction signals to the NIC clock; and
responsive to synchronizing clocks of the plurality of NICS of the server with the system clock, determining timestamps for packet transmission and reception for the server based on the NIC clocks of the plurality of NICs, wherein each NIC clock is synchronized with the system clock.

2. The method of claim 1, further comprising:
determining a synchronization interval based on a rate of change of the system clock and one or more environmental factors.

3. The method of claim 2, wherein the one or more environmental factors comprise temperature variations and vibration levels.

4. The method of claim 2, wherein the synchronization interval is shortened responsive to detecting more variations of clock frequency at more than a threshold rate.

5. The method of claim 2, wherein the synchronization interval determined is based on environmental telemetry received from sensors associated with the NICs.

6. The method of claim 1, further comprising:
responsive to determining an adjustment to the system clock, propagating corrections to each of the clocks of the plurality of NICs, wherein the corrections are determined based on the adjustment to the system clock.

7. The method of claim 1, further comprising:
performing two-way network time-offset estimation between the server and one or more remote servers, wherein the timestamps used in the two-way network time-offset estimation are based on the clocks of the plurality of NICs synchronized with the system clock.

8. The method of claim 1, wherein synchronizing of clocks further comprises:
estimating the time offset and the frequency drift between each follower clock and the system clock over a plurality of spaced timestamp samples using a linear regression model.

9. The method of claim 1, wherein determining the time offset and the frequency drift includes applying a filter to reduce noise in measurements made for determining the time offset and the frequency drift.

10. The method of claim 1, further comprising:
responsive to detecting a correction applied to the system clock, propagating corrections to a follower clock by applying a clock-correction signal to the follower clock.

11. A non-transitory computer readable storage medium storing instructions that when executed by one or more computer processors cause the one or more computer processors to perform steps comprising:
determining, by a server, timestamps for packet transmission and reception, the server comprising a system clock and plurality of NICs, each NIC including a clock;
synchronizing clocks of the plurality of NICS of the server with the system clock of the server, comprising, for each follower clock:
determining a time offset and a frequency drift of the follower clock with respect to the system clock,
determining correction signals for correcting the time offset and the frequency drift of the follower clock, and
synchronizing the follower clock with the system clock by applying the correction signals to the follower clock; and
responsive to synchronizing clocks of the plurality of NICS of the server with the system clock, determining timestamps for packet transmission and reception for the server based on the synchronized clocks of the plurality of NICs.

12. The non-transitory computer readable storage medium of claim 11, further comprising:
determining a synchronization interval based on a rate of change of the system clock and one or more environmental factors.

13. The non-transitory computer readable storage medium of claim 12, wherein the one or more environmental factors comprise temperature variations and vibration levels.

14. The non-transitory computer readable storage medium of claim 12, wherein the synchronization interval is shortened responsive to detecting more variations of clock frequency at more than a threshold rate.

15. The non-transitory computer readable storage medium of claim 12, wherein the synchronization interval determined is based on environmental telemetry received from sensors associated with the NICs.

16. The non-transitory computer readable storage medium of claim 11, further comprising:
responsive to determining an adjustment to the system clock, propagating corrections to each of the clocks of the plurality of NICs, wherein the corrections are determined based on the adjustment to the system clock.

17. The non-transitory computer readable storage medium of claim 11, further comprising:
performing two-way network time-offset estimation between the server and one or more remote servers, wherein the timestamps used in the two-way network time-offset estimation are based on the clocks of the plurality of NICs synchronized with the system clock.

18. The non-transitory computer readable storage medium of claim 11, wherein synchronizing of clocks further comprises:
estimating the time offset and the frequency drift between each follower clock and the system clock over a plurality of spaced timestamp samples using a linear regression model.

19. The non-transitory computer readable storage medium of claim 11, wherein determining the time offset and the frequency drift includes applying a filter to reduce noise in measurements made for determining the time offset and the frequency drift.

20. A computer system comprising:
one or more computer processors; and
a non-transitory computer readable storage medium storing instructions that when executed by one or more computer processors cause the one or more computer processors to perform steps comprising:
determining, by a server, timestamps for packet transmission and reception, the server comprising a system clock and plurality of NICs, each NIC including a clock;
synchronizing clocks of the plurality of NICS of the server with the system clock of the server, comprising, for each follower clock:
determining a time offset and a frequency drift of the follower clock with respect to the system clock,
determining correction signals for correcting the time offset and the frequency drift of the follower clock, and
synchronizing the follower clock with the system clock by applying the correction signals to the follower clock; and
responsive to synchronizing clocks of the plurality of NICS of the server with the system clock, determining timestamps for packet transmission and reception for the server based on the synchronized clocks of the plurality of NICs.
